(19) United States
(12) Patent Application Publication
(10) Pub. No.: US 2008/0166018 A1
(43) Pub. Date: Jul. 10, 2008

(54) METHOD AND APPARATUS FOR PERFORMING OBJECT RECOGNITION ON A TARGET DETECTED USING MOTION INFORMATION

(75) Inventors: ZHIYUAN Z. LI, LAKE ZURICH, IL (US); DANIEL A. LINZMEIER, WHEELING, IL (US); BEI TANG, PALATINE, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/620,082

(22) Filed: Jan. 5, 2007

(51) Int. Cl. G06K 9/00

(52) U.S. Cl. 382/105

(57) ABSTRACT

A system includes an interface that receives an image, which includes a motor vehicle and background, and a processing device that performs a method for object recognition on the received image. The method includes the steps of: determining motion information corresponding to at least one of the moving vehicle and the background; detecting the moving vehicle in the image using the motion information; detecting an object of interest on the moving vehicle; and performing an object recognition process on the object of interest. The system may be part of a license plate recognition system.

### TECHNICAL FIELD

The present invention relates generally to object recognition systems and more particularly to using motion information to segment a moving motor vehicle from background information in an image, in order to more effectively perform object recognition for an object of interest on the moving vehicle.

### BACKGROUND

License plate recognition (LPR) technology (a form of object recognition technology) is used to automatically read license plates in order to implement a wide range of traffic monitoring systems, such as tolling, traffic monitoring for traffic violations, etc. Current LPR systems locate license plates in an image (or video sequence) using contrast or vertical line frequency information as applied to the entire image without attempting to segment moving automotive or “motor” vehicles (also simply referred to herein as “vehicles”) from background in the image. As used herein, the term motor vehicle or vehicle includes any machine that includes a motor (sometimes referred to as an engine) and that is used for transportation on land, examples of which include automobiles, trucks, busses, motorcycles and the like. The assumption upon which such systems are based is that the frequency of license plate regions containing characters is significantly higher than the frequency in the rest of the image. While this may hold true on images that consist only of a vehicle, this is not necessarily the case where the image contains complex background. Accordingly, in the case where an image contains such complex background, the accuracy of the prior LPR systems greatly suffers.

Known LPR systems also suffer from constraints that place further limits on the system. For example, these systems generally require the use of special devices such as infrared (IR) lighting (e.g., using light emitting diodes (LEDs)) and IR filters, which increases the cost of the systems. In a tolling application, for instance, a minimum of 2,700 LEDs is typically required. Moreover, these systems usually place constraints on the size of the license plate, which limits the number of workable frames and wastes bandwidth.

Thus, there exists a need for a more accurate object recognition system and corresponding method that do not have the constraints of the prior art systems. It is further desirable that the object recognition system be implementable as a license plate recognition system without the need for expensive IR lighting and filters required in the prior art systems.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a system in which embodiments of the invention can be implemented.

FIG. 2 is an image containing a moving vehicle and background that is captured by the system of FIG. 1.

FIG. 3 is a flow diagram illustrating a method for performing object recognition on the image of FIG. 2, in accordance with embodiments of the invention.

FIG. 4 is a functional block diagram of a process performed for license plate recognition on the image of FIG. 2, in accordance with embodiments of the invention.

FIG. 5 illustrates the image of FIG. 2 after the moving vehicle has been extracted using the process of FIG. 4, in order to perform (only on the extracted moving vehicle) the further license plate detection and recognition, in accordance with embodiments of the invention.

### DETAILED DESCRIPTION

Before describing in detail embodiments that are in accordance with the present invention, it should be observed that the embodiments reside primarily in combinations of method steps and apparatus components related to a method and apparatus for object recognition for an object of interest on a motor vehicle detected using motion information. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for object recognition for an object of interest on a motor vehicle detected using motion information described herein. The non-processor circuits may include, but are not limited to, a radio receiver, a radio transmitter and user input devices. As such, these functions may be interpreted as steps of a method to perform the object recognition for an object of interest on a motor vehicle detected using motion information described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a method, system and computer readable storage element provides for an object recognition process for an object of interest detected on a moving vehicle, wherein the moving vehicle was first extracted, using motion information, from an image comprising both the moving vehicle and background. The system can comprise a license plate recognition system, wherein the object of interest detected on the vehicle is a license plate, and a license plate recognition process that comprises a character recognition process that is performed to read the license plate.

After detecting a moving vehicle, size and aspect ratio of the vehicle can be extracted and used to estimate size of the license plate, which eliminates the plate size restrictions of the prior art techniques and improves overall accuracy of license plate location over the prior art techniques. Moreover, after detecting a moving vehicle, the process can be configured to search only predetermined regions on the vehicle for potential plate candidates to reduce computation complexity and, again, improve overall accuracy of license plate location. Furthermore, after detecting the vehicle, exposure setting of an image capture device that captured the image can be tuned for best exposure on the vehicle, thereby, improving contrast between the plate and the vehicle and contrast between the plate background and plate text.

The character recognition process used for reading the license plate can take advantage of the more accurate plate location information provided using embodiments of the invention in order to reduce character segmentation errors introduced from a partially detected plate. In addition, using motion information to extract the moving vehicle from the background and locating the license plate only on the extracted vehicle (instead of the entire image as in the prior art) eliminates the need for the special and costly lighting and filter devices described above. Those skilled in the art will realize that the above recognized advantages and other advantages described herein are merely exemplary and are not meant to be a complete rendering of all of the advantages of the various embodiments of the present invention.

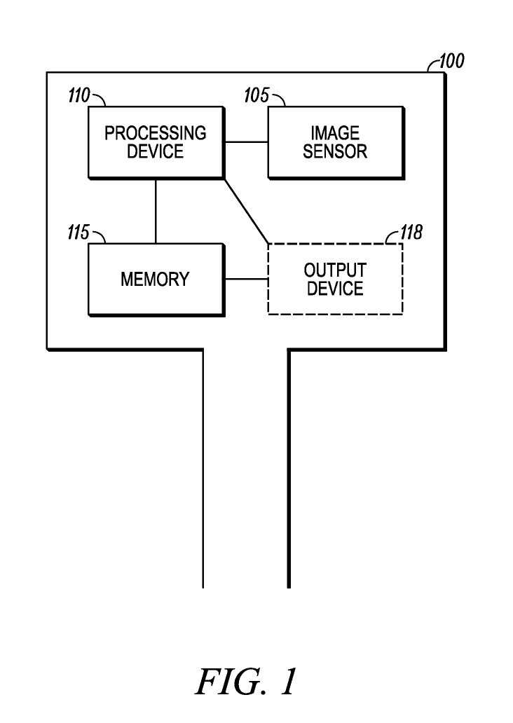

Referring now to the drawings, and in particular FIG. 1, an exemplary system that can implement embodiments of the invention is shown and indicated generally at 100. More particularly, FIG. 1 illustrates a camera 100 that can acquire and process images according to embodiments of the invention. As shown, the camera 100 includes: an image sensor 105 to capture an image (also referred to herein as an “image capture device”); a processing device 110 (implemented in any form as discussed above) to process the captured image; and a memory 115, such as for instance a Read Only Memory, a Random Access Memory or a combination thereof, to store program code executable by the processing device 110, a representation of the image and additional images where needed and motion information for employing embodiments of the invention. For example, images may be stored as Joint Photographic Experts Group (“JPEG”) images or Moving Picture Experts Group (“MPEG”) images in the memory 115. The camera 100 may also include an output device 118 such as a display screen for a user to view the image or portions thereof or a modem to communicate the image and/or data with other cameras, servers, or databases, or any other related device used for or related to the processing of images.

Camera 100 can be configured to be a still image camera that captures still images, a video camera that captures a sequence of frames each comprising an image (as the term is further used herein), or both. Moreover, camera 100 can be a stationary camera such as those positioned at a traffic light or toll booth or a mobile camera such as one mounted on a law enforcement vehicle. In addition, exemplary camera 100 is logically shown as having all of its elements, including an interface between the processing device and the image sensor, embodied in a single device. It alternative implementations, any one or more of the logical elements or portions thereof shown in apparatus 100 can be physically embodied in multiple devices. For example, the image sensor may comprise a separate physical device from the processing device, whereby, the interface connecting them is a suitable wireless interface or a wired interface, or portions of the processing device may be embodied in separate physical devices.

The camera 100 in operation acquires images of a moving motor vehicle and background to the moving vehicle such as, for instance, trees, traffic signs, buildings, etc. The moving vehicle may include a license plate, the numbers or other symbols on which may be determined by analyzing the images via an object/character recognition process implemented by the processing device 110 and/or an additional processing device contained within or outside of the camera 100. Accordingly, in an embodiment, the camera 100 may be utilized, e.g. to monitor vehicle traffic through an intersection and determine the objects/characters on a license plate of a vehicle speeding through a traffic signal or violating some other traffic law. By acquiring the images, detecting and extracting the moving vehicle using motion information and then analyzing the only the extracted moving vehicle representation to determine the objects/characters on the license plate, in accordance with the teachings herein, the identity of the vehicle may be automatically determined so that a citation may be sent to the owner of the vehicle. In such an implementation, camera 100, thus, comprises a motor vehicle license plate recognition system. Besides traffic monitoring systems, alternative applications include camera 100 being included in highway tolling systems, crime area vehicle monitoring, and the like.

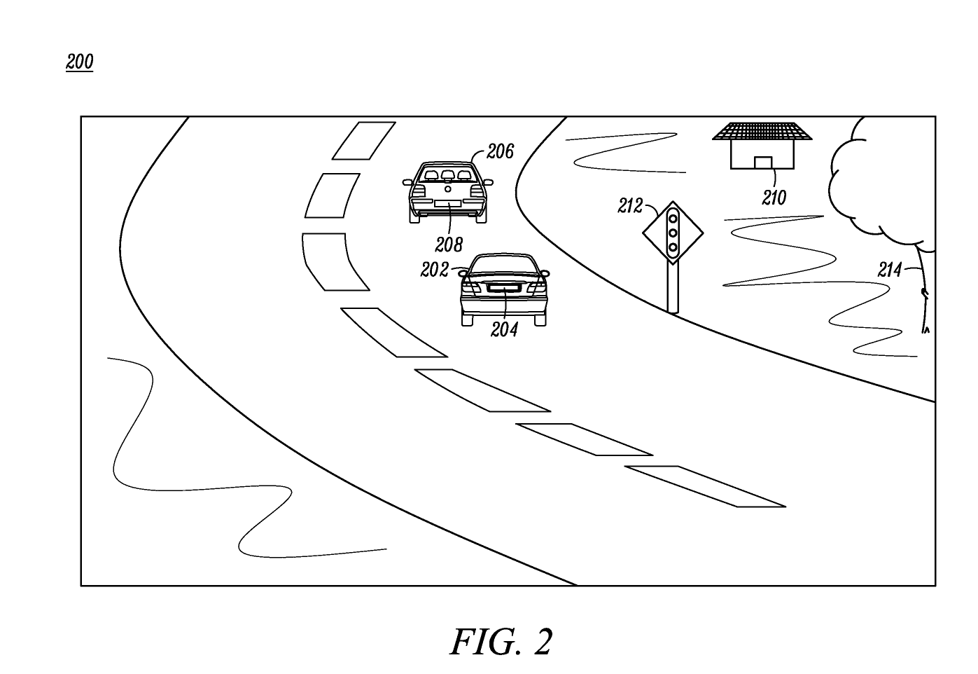

Turning now to FIG. 2, an image captured by the sensor 105 is shown and generally indicated at 200. Image 200 can be a still image or a frame of a video sequence, depending on the type of sensor used. Shown in image 200 is representations of a moving vehicle 202 having a license plate 204 mounted thereon and a portion of another moving vehicle 206 having a license plate 208 mounted thereon. Further shown in image 200 is background (to the vehicles), comprising a building structure 210, a road sign 212 and a tree 214. Methods and processes in accordance with embodiments of the invention can be used to process image 200.

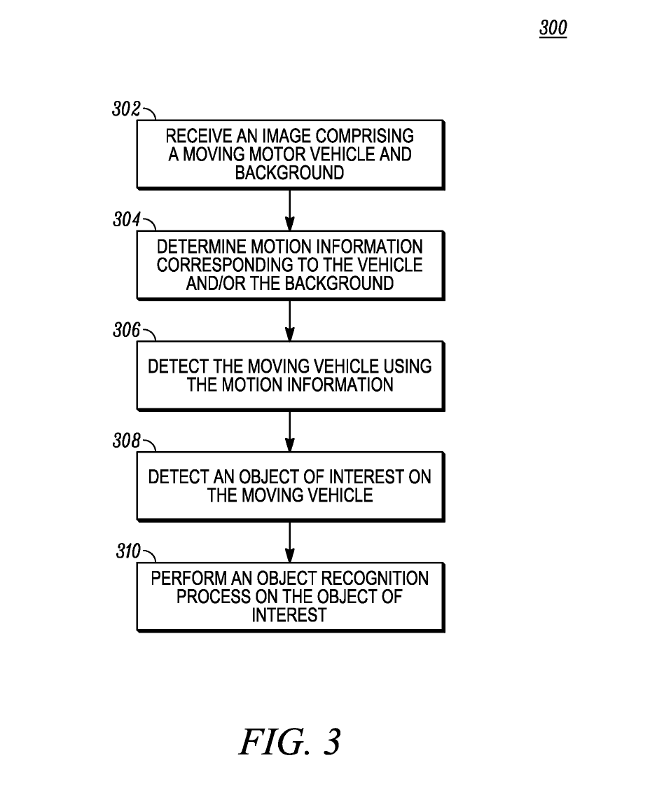

FIG. 3 is a flow diagram illustrating a method 300 for performing object recognition on the image of FIG. 2, in accordance with embodiments of the invention. In general, method 300 comprises the steps performed by processing device 100 of: receiving (or reading) (302) an image (e.g., image 200) comprising a moving motor vehicle and background; determining (304) motion information corresponding to the moving vehicle, the background or both; detecting/extracting (306) the moving vehicle in the image using the motion information; detecting (308) an object of interest (e.g., a license plate, tail lights, etc.) on the moving vehicle; and performing (310) at least one object recognition process (e.g., a license plate recognition process) on the object of interest.

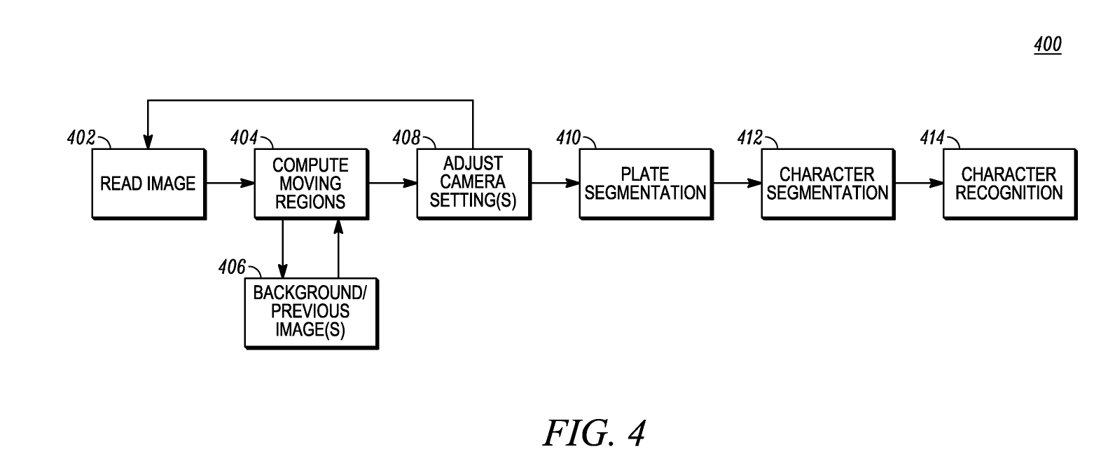

FIG. 4 is a functional block diagram of a process 400 performed for license plate recognition on the image of FIG. 2, in accordance with embodiments of the invention. At a block 402 a current image 200 is read (e.g., received from the sensor 105, obtained from memory 115, etc.). Motion information is determined at block 404 to use in detecting a moving vehicle (e.g., vehicle 202, vehicle 206 or both). However, to simplify explanation, the current discussion will focus on detecting vehicle 202, and it should be understood that the same processing steps can be performed to likewise detect vehicle 206 and thereafter perform the remaining process steps related to object recognition. Moreover, although image 200 only shows two moving vehicle for ease of illustration, process 400 can be used to detect any number of moving vehicle in an image and thereafter perform object recognition only on the detected vehicles.

To compute the moving regions in image 200 any suitable motion detection algorithm can be used. In a general sense, motion metrics as corresponds to the content of image 200 are computed. Such motion metrics and their manner of ascertainment are known in the art and typically correspond to apparent movement of a region of interest during a given amount of time. Such motion metrics are often characterized as a corresponding motion vector to facilitate, for example, their ready use in mathematical application. In the case where, for example, an MPEG video sequence is available, the motion vector can be directly extracted, if desired, from the MPEG data stream itself.

In addition, many methods for determining motion metrics use difference information between two images. Accordingly, box 406 supplies one or more previous images (e.g., from memory 115), which can be used in box 404 to compute the motion metrics needed to segment vehicle 202 from image 200. For example, in one implementation box 404 may perform a pixel by pixel subtraction of motion metrics between two images (e.g., image 200 and an image supplied by box 406) to generate a difference result that is compared to a suitable threshold to determine moving regions. Namely, those difference values that are less than the threshold are counted as background and can be cancelled from image 200, and those difference values that exceed the threshold are segmented out as comprising the moving vehicle 202.

Moreover as stated earlier, in one implementation camera 100 may be a mobile camera. In such a case, block 404 further estimates background motion attributed to the camera and further cancels this background motion from image 200 and any previous images as needed before applying a difference method to segment moving vehicle 202. In one implementation, box 404 can use an affine transformation and LMedS (Least median squared) method to estimate the apparent background motion. If the moving vehicle is not detected, this means that either there is no moving vehicle in the image or that the relative motion of the vehicle is too small to be detected. In the latter case, it is possible to detect the moving vehicle by adjusting a setting in the camera, for instance the frame rate, using box 408 and to determine motion metrics (404) as corresponds to a new image captured using the adjusted camera settings. As the present teachings are not overly sensitive to the use of any particular motion vector value calculation method or any other method for determining motion information, and further as such methods are otherwise generally well known in the art, for the sake of brevity and the preservation of narrative focus additional detail regarding such methods will not be provided here.

Where the moving vehicle is detected, other camera settings may likewise be adjusted (usually automatically) in block 408 such as exposure (contrast level), gain, zoom, etc., to improve the representation of the moving vehicle in order to improve the license plate recognition process that follows. Thus, block 408 can be used to zoom in on detected moving vehicles to locate plates on a vehicle that are at a distance from the sensor. Additionally, in one exemplary implementation of block 408, the contrast level of the ROI, which in this case is the segmented moving vehicle 200, is measured and sensor settings are adjusted to achieve an optimal contrast in the ROI. The contrast level may be measured by, e.g. calculating the sum of the absolute differences between pixels in the ROI to determine whether it meets object recognition requirements. If it does not, the sensor black level calibration value and/or other sensor settings are adjusted to increase the image's ROI contrast until it reaches an optimal contrast range. Once the contrast level has been optimized, a new image is captured (402) with the optimized sensor settings, and the new image may then be analyzed in motion detection block 404. Tuning the contrast levels in this manner improves the contrast between the moving vehicle and the plate and the contrast between the plate background and the plate text.

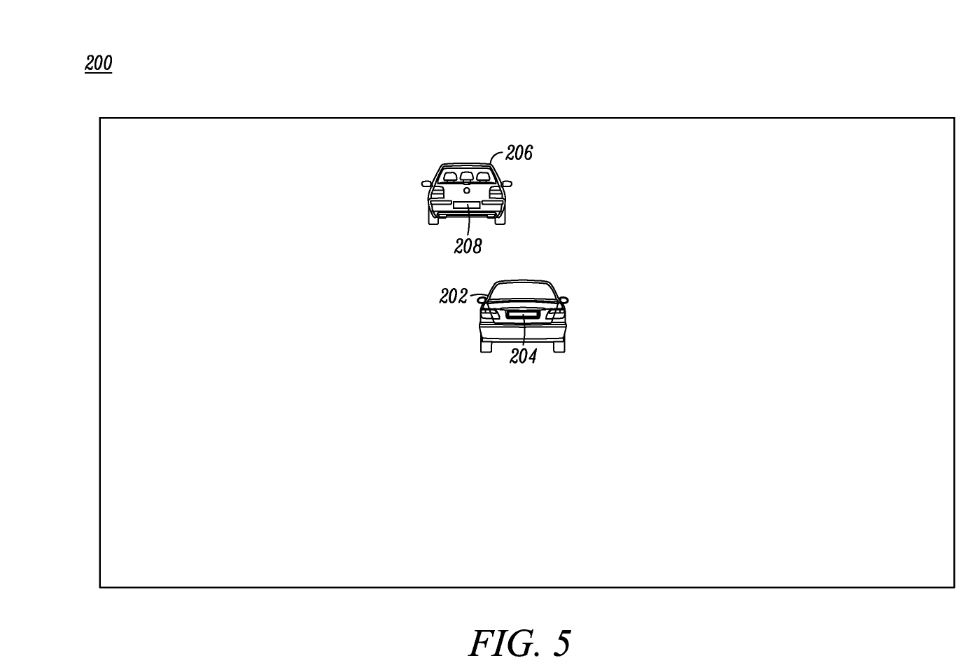

Once a satisfactory ROI has been extracted based on a stopping criterion, such as a contrast level threshold that meets certain object recognition requirements, the process exits the loop between block 402 through 408 so that a license plate recognition process (e.g., blocks 410, 412, 414) can be performed only on the ROI (the moving vehicle) instead of on the entire image as in the prior art. FIG. 5 shows image 200, for example, with the background having been cancelled such that only the ROI, which comprises the moving vehicles 202 and 206, are further processed in blocks 410, 412 and 414.

At block 410 license plate segmentation is performed on the moving vehicle representation 202 to detect the license plate 204 mounted thereon, which is an object of interest in this implementation. Any suitable plate finding algorithm can be used in this block without limiting the scope of the teachings herein. For example, block 410 can use vertical line and frequency information to detect transitions meeting a frequency requirement that would indicate that a license plate character may have been encountered. Use of vertical line and frequency information in this context is much more effective than its use in the prior art since the technique is performed only on the detected vehicle in accordance with the teachings herein.

Further information can be used to verify a preliminary plate location. In one implementation only certain predefined areas or regions on the detected vehicle are searched for potential plate candidates. For example, the search may at least start in a lower middle region of the vehicle, since this is an area where a plate is most likely to be found. Such a regional-based location focus reduces computation complexity and improves accuracy of the plate locating process. In addition, since the vehicle 202 has been detected, block 410 can further detect at least one or more geometric parameters of the vehicle such as, for instance, a size of the vehicle, an aspect ratio of the vehicle, etc. to enhance the plate location process. For instance, block 410 can use the size and aspect ratio of the vehicle to estimate the size of the license plate, which eliminates plate size restrictions and further improves overall plate location accuracy. Moreover, other objects of interest such as, for instance, tail lights or other portions on the vehicle can be located using a corresponding object recognition process tailored to the particular object of interest and used to verify correct location of the license plate.

Blocks 412 and 414 comprise the object recognition process, which in this instance is used to read the license plate. These blocks can be implemented as an Optical Character Recognition (OCR) engine. Block 412 identifies individual characters in the license plate region that was segmented in block 410. This can be done, for example, by finding and tracing a contour along interior portions of the character edges, and the contour length, character height and character width are verified to be within acceptable predetermined ranges. Since the plate was more accurately detected using the embodiments described herein, obscuring objects on the plate (e.g., a license plate frame covering portions of the characters) can be more easily compensated for, thereby, reducing character segmentation errors. Character recognition block 414 performs a structural analysis on the detected characters to identify each one. For example, parameters including, but not limited to, shape of the convex hull, shape, number and position of bays, and shape, position and number of holes can be determined and used to identify each character. However, any suitable OCR engine could be used.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for performing object recognition on an image comprising a moving motor vehicle, the method comprising the steps of:
receiving an image comprising a moving motor vehicle and background;
determining motion information corresponding to at least one of the moving vehicle and the background;
detecting the moving vehicle in the image using the motion information;
detecting an object of interest on the moving vehicle; and
performing an object recognition process on the object of interest.

2. The method of claim 1, wherein the step of detecting an object of interest comprises searching a predefined area on the detected moving vehicle where the object of interest is expected to be found.

3. The method of claim 1, wherein detecting the object of interest comprises detecting a license plate, and performing the object recognition process comprises performing a license plate recognition process.

4. The method of claim 3 further comprising the step of detecting at least one geometric parameter associated with the moving vehicle.

5. The method of claim 4, wherein the step of detecting the object of interest comprises estimating a size of the license plate based on the at least one detected geometric parameter.

6. The method of claim 4, wherein the at least one geometric parameter comprises at least one of a size of the moving vehicle and an aspect ratio of the moving vehicle.

7. The method of claim 1, wherein the image comprises one of a still image and a frame of a video sequence.

8. The method of claim 1, wherein determining motion information further comprises determining motion information corresponding to an image capture device that captures the image, wherein the moving vehicle is further detected using the motion information corresponding to the image capture device.

9. The method of claim 1, wherein determining motion information and detecting the moving vehicle comprises the steps of:
determining motion information corresponding to the background in the image and in another image captured previous in time; and
cancelling the motion information corresponding to the background from the image to detect the moving vehicle.

10. The method of claim 1 further comprising iteratively performing the steps of adjusting a setting of an image capture device that captured the image based on the detected moving vehicle, receiving another image captured using the adjusted setting, determining the motion information from the received image, and detecting the moving vehicle until a predetermined stopping criterion is reached.

11. The method of claim 1, wherein the step of determining the motion information further comprises determining motion information corresponding to a second moving motor vehicle, the method further comprising the steps of:
detecting the second moving vehicle in the image using the motion information;
detecting a second object of interest on the second moving vehicle; and
performing an object recognition process on the second object of interest.

12. The method of claim 1, wherein the motion information comprises a plurality of motion vectors.

13. Apparatus for performing object recognition on an image comprising a moving motor vehicle, the apparatus comprising:
an interface for receiving an image comprising a moving motor vehicle and background; and
a processing device configured for performing the steps of:
determining motion information corresponding to at least one of the moving motor vehicle and the background;
detecting the moving vehicle in the image using the motion information;
detecting an object of interest on the moving vehicle; and
performing an object recognition process on the object of interest.

14. The apparatus of claim 13 further comprising an image capture device for capturing the image and providing the image to the processing device via the interface.

15. The apparatus of claim 14, wherein the image capture device is a mobile image capture device.

16. The apparatus of claim 14, wherein the image capture device is one of a still image camera and a video camera.

17. The apparatus of claim 13, wherein the apparatus comprises a motor vehicle license plate recognition system.

18. The apparatus of claim 13 further comprising a memory device storing at least one of another image captured previous in time and comprising the background and motion information corresponding to the background in the image captured previous in time.

19. A computer-readable storage element having computer readable code stored thereon for programming a computer to perform a method for performing object recognition on an image comprising a moving motor vehicle, the method comprising the steps of:
receiving an image comprising a moving motor vehicle and background;
determining motion information corresponding to at least one of the moving vehicle and the background;
detecting the moving vehicle in the image using the motion information;
detecting an object of interest on the moving vehicle; and
performing an object recognition process on the object of interest.

20. The computer-readable storage medium of claim 19, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
